(19) United States
(12) Patent Application Publication
(10) Pub. No.: US 2022/0242415 A1
(43) Pub. Date: Aug. 4, 2022

(54) DYNAMICALLY-LOCALIZED SENSORS FOR VEHICLES

(71) Applicant: Motional AD LLC, Boston, MA (US)

(72) Inventor: Eryk Brian Nice, Medford, MA (US)

(21) Appl. No.: 17/162,747

(22) Filed: Jan. 29, 2021

(51) Int. Cl. B60W 40/04; B60W 50/02; B60W 60/00

(52) U.S. Cl. CPC B60W 40/04; B60W 50/0205; B60W 60/001; B60W 2420/52; B60W 2554/4041; B60W 2554/4049; B60W 2556/45

(57) ABSTRACT

Among other things, techniques are described for a system including at least one sensor, at least one sensor comprising at least one attachment configured to removably attach to an auxiliary vehicle, the auxiliary vehicle configured for attachment to a primary vehicle; at least one computer-readable medium storing computer-executable instructions; at least one first processor communicatively coupled to the at least one sensor and configured to execute the computer-executable instructions, the execution carrying out operations including: receiving data corresponding to an environment of the auxiliary vehicle from the at least one sensor; determining at least one dimension of the auxiliary vehicle and a relative position of the at least one sensor from a primary vehicle based on the environment of the auxiliary vehicle; and providing the at least one dimension and the relative position of the at least one sensor to the primary vehicle based on the at least one dimension of the auxiliary vehicle and the relative position of the at least one sensor.

### FIELD OF THE INVENTION

This description relates to dynamically-localized sensors for vehicles, e.g. for trailering.

### BACKGROUND

Autonomous vehicles use a suite of sensors and communication devices to update their localization states while navigating their environment from one destination to the next. Trailered vehicles obstruct sensor lines of sight reducing the vehicle localization accuracy and awareness of surroundings. Trajectory planning is also impeded as trailered vehicles greatly decrease the positional accuracy of the autonomous vehicle, particularly in maneuvers which require high accuracy such as cornering.

### BRIEF DESCRIPTION OF THE DRAWINGS

FIG. 1 shows an example of an autonomous vehicle having autonomous capability.

FIG. 2 shows a computer system.

FIG. 3 shows an example architecture for an autonomous vehicle.

FIG. 4 shows an example of inputs and outputs that can be used by a perception module.

FIG. 5 shows an example system diagram of a trailering system and communication with an example autonomous vehicle computer system.

FIG. 6A shows a side-view of an example autonomous vehicle with integrated sensors.

FIG. 6B shows a side-view of an example autonomous vehicle connected to a trailered vehicle with temporary sensors.

FIG. 6C shows a top-view of an example autonomous vehicle connected to a trailered vehicle with temporary sensors.

FIG. 7 shows a perspective drawing of the trailered vehicle connected to an autonomous vehicle with attached temporary sensors.

FIG. 8 is a flowchart of a process for providing at least one dimension of a trailered vehicle to an autonomous vehicle using a trailering system, in accordance with one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. System Overview
3. Autonomous Vehicle Architecture
4. Autonomous Vehicle Inputs
5. Trailering System for Auxiliary Vehicles
6. Exemplary Embodiment

### General Overview

The addition of temporarily-mountable sensors to at least one point on a trailer attached to a vehicle (e.g., an autonomous vehicle, a semi-autonomous vehicle, and/or the like) provides supplemental coverage of the vehicle's surroundings and more precise positioning data. Normally, the trailer occludes a portion of the vehicle's surroundings, particularly the ability to sense objects behind or to the side of the vehicle. Further, this occlusion changes as the combined vehicle maneuvers and the trailer position changes relative to the AV. Thus, the additional sensors enable the vehicle to sense the surroundings that would have otherwise been occluded.

Some of the advantages of these techniques include generating and providing data associated with a precise size and shape of the combined vehicle and trailer for controls and path planning implemented using an AV computer system. The sensors provide accurate trailer position information with respect to the AV which aids in reducing the positional error of trailer swing during maneuvering. Increasing trailer localization accuracy has benefits in combined vehicle safety and control during movement choreography. The temporary sensors also provide supplemental computation capability, processing received data into a trailer localization estimation before providing it to the AV sensor suite. Additionally, dynamically positioning the sensors using temporary fixtures allows for flexibility in trailered item dimensions when combined with the vehicle sensor suite. A portable sensor suite is adaptable to any trailered item lending flexibility and economic efficiency to the system. Additional safety applications can include relative positioning error positional detection, such as fish-tailing or jack-knifing, object detection, or poor load distribution.

### System Overview

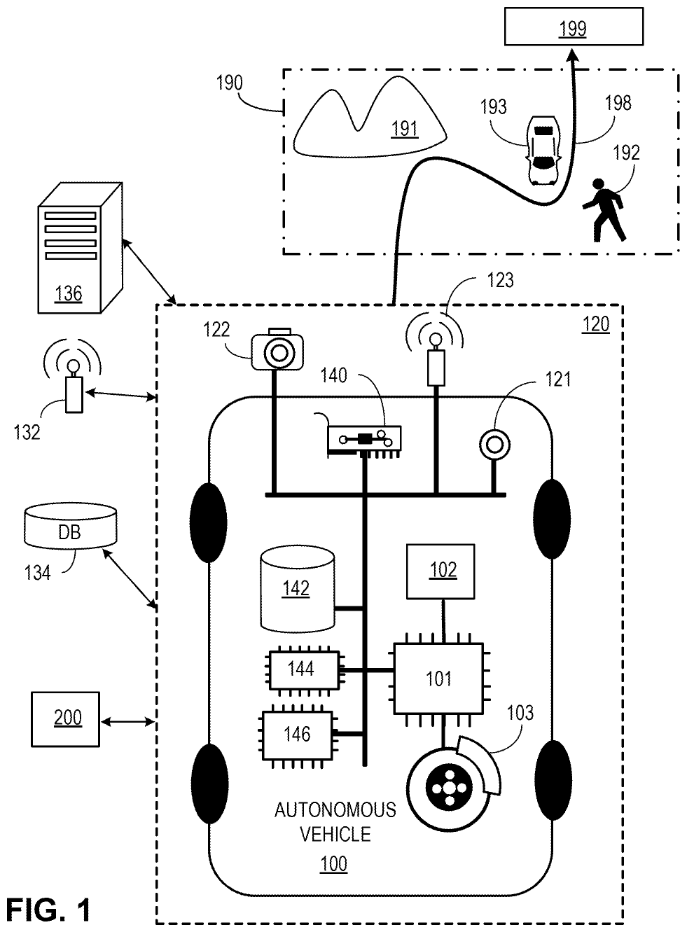

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of at least one segments (e.g., sections of road) and each segment is made up of at least one blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes at least one hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes at least one classified or labeled objects detected by at least one sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

The term “over-the-air (OTA) client” includes any AV, or any electronic device (e.g., computer, controller, IoT device, electronic control unit (ECU)) that is embedded in, coupled to, or in communication with an AV.

The term “over-the-air (OTA) update” means any update, change, deletion or addition to software, firmware, data or configuration settings, or any combination thereof, that is delivered to an OTA client using proprietary and/or standardized wireless communications technology, including but not limited to: cellular mobile communications (e.g., 2G, 3G, 4G, 5G), radio wireless area networks (e.g., WiFi) and/or satellite Internet.

The term “edge node” means at least one edge devices coupled to a network that provide a portal for communication with AVs and can communicate with other edge nodes and a cloud based computing platform, for scheduling and delivering OTA updates to OTA clients.

The term “edge device” means a device that implements an edge node and provides a physical wireless access point (AP) into enterprise or service provider (e.g., VERIZON, AT&T) core networks. Examples of edge devices include but are not limited to: computers, controllers, transmitters, routers, routing switches, integrated access devices (IADs), multiplexers, metropolitan area network (MAN) and wide area network (WAN) access devices.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of at least one of the associated listed items. It will be further understood that the terms “includes,” “including,” “comprises,” and/or “comprising,” when used in this description, specify the presence of stated features, integers, steps, operations, elements, and/or components, but do not preclude the presence or addition of at least one other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment.

In general, this document describes technologies applicable to any vehicles that have at least one autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, at least one of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Autonomous vehicles have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the vehicle 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

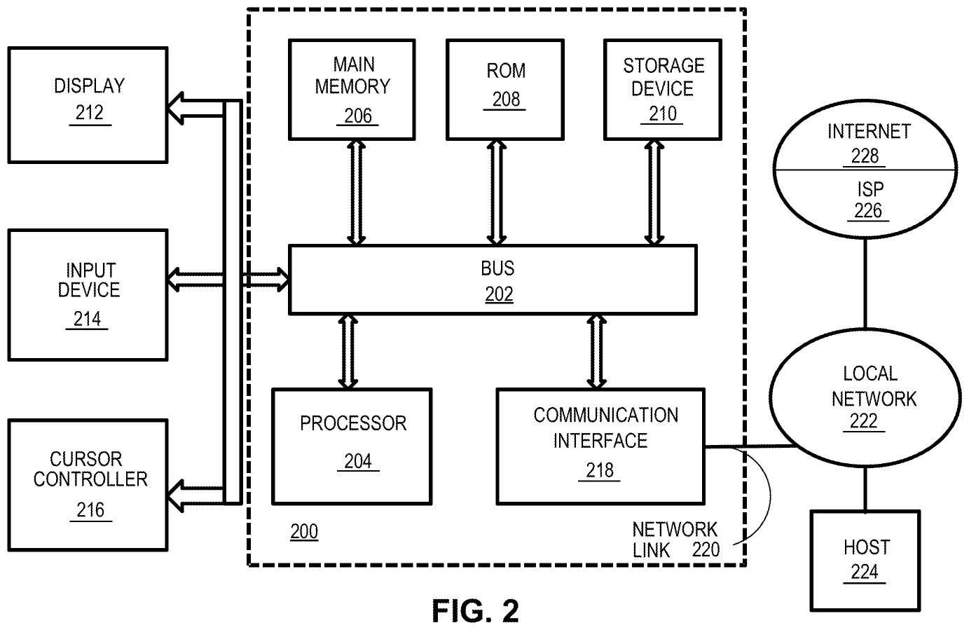

In an embodiment, the AV system 120 includes devices 101 that are instrumented to receive and act on operational commands from the computer processors 146. We use the term “operational command” to mean an executable instruction (or set of instructions) that causes a vehicle to perform an action (e.g., a driving maneuver). Operational commands can, without limitation, including instructions for a vehicle to start moving forward, stop moving forward, start moving backward, stop moving backward, accelerate, decelerate, perform a left turn, and perform a right turn. In an embodiment, computer processors 146 are similar to the processor 204 described below in reference to FIG. 2. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the vehicle 100, such as the AV's position, linear and angular velocity and acceleration, and heading (e.g., an orientation of the leading end of vehicle 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 208 or storage device 210 described below in relation to FIG. 2. In an embodiment, memory 144 is similar to the main memory 206 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the vehicle 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the vehicle 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, at least one other types of communication) is sometimes referred to as Vehicle-to-Everything (V2X) communication. V2X communication typically conforms to at least one communications standards for communication with, between, and among autonomous vehicles.

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment. The communication devices 140 transmit data collected from sensors 121 or other data related to the operation of vehicle 100 to the remotely located database 134. In an embodiment, communication devices 140 transmit information that relates to teleoperations to the vehicle 100. In some embodiments, the vehicle 100 communicates with other remote (e.g., “cloud”) servers 136.

In an embodiment, the remotely located database 134 also stores and transmits digital data (e.g., storing data such as road and street locations). Such data is stored on the memory 144 on the vehicle 100, or transmitted to the vehicle 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data can be stored on the memory 144 on the vehicle 100, or transmitted to the vehicle 100 via a communications channel from the remotely located database 134.

Computer processors 146 located on the vehicle 100 algorithmically generate control actions based on both real-time sensor data and prior information, allowing the AV system 120 to execute its autonomous driving capabilities.

In an embodiment, the AV system 120 includes computer peripherals 132 coupled to computer processors 146 for providing information and alerts to, and receiving input from, a user (e.g., an occupant or a remote user) of the vehicle 100. In an embodiment, peripherals 132 are similar to the display 212, input device 214, and cursor controller 216 discussed below in reference to FIG. 2. The coupling is wireless or wired. Any two or more of the interface devices can be integrated into a single device.

In an embodiment, the AV system 120 receives and enforces a privacy level of a passenger, e.g., specified by the passenger or stored in a profile associated with the passenger. The privacy level of the passenger determines how particular information associated with the passenger (e.g., passenger comfort data, biometric data, etc.) is permitted to be used, stored in the passenger profile, and/or stored on the cloud server 136 and associated with the passenger profile. In an embodiment, the privacy level specifies particular information associated with a passenger that is deleted once the ride is completed. In an embodiment, the privacy level specifies particular information associated with a passenger and identifies at least one entities that are authorized to access the information. Examples of specified entities that are authorized to access information can include other AVs, third party AV systems, or any entity that could potentially access the information.

A privacy level of a passenger can be specified at least one levels of granularity. In an embodiment, a privacy level identifies specific information to be stored or shared. In an embodiment, the privacy level applies to all the information associated with the passenger such that the passenger can specify that none of her personal information is stored or shared. Specification of the entities that are permitted to access particular information can also be specified at various levels of granularity. Various sets of entities that are permitted to access particular information can include, for example, other AVs, cloud servers 136, specific third party AV systems, etc.

In an embodiment, the AV system 120 or the cloud server 136 determines if certain information associated with a passenger can be accessed by the AV 100 or another entity. For example, a third-party AV system that attempts to access passenger input related to a particular spatiotemporal location must obtain authorization, e.g., from the AV system 120 or the cloud server 136, to access the information associated with the passenger. For example, the AV system 120 uses the passenger's specified privacy level to determine whether the passenger input related to the spatiotemporal location can be presented to the third-party AV system, the AV 100, or to another AV. This enables the passenger's privacy level to specify which other entities are allowed to receive data about the passenger's actions or other data associated with the passenger.

FIG. 2 shows a computer system 200. In an implementation, the computer system 200 is a special purpose computing device. The special-purpose computing device is hard-wired to perform the techniques or includes digital electronic devices such as at least one application-specific integrated circuits (ASICs) or field programmable gate arrays (FPGAs) that are persistently programmed to perform the techniques, or can include at least one general purpose hardware processors programmed to perform the techniques pursuant to program instructions in firmware, memory, other storage, or a combination. Such special-purpose computing devices can also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 200 includes a bus 202 or other communication mechanism for communicating information, and a processor 204 coupled with a bus 202 for processing information. The processor 204 is, for example, a general-purpose microprocessor. The computer system 200 also includes a main memory 206, such as a random-access memory (RAM) or other dynamic storage device, coupled to the bus 202 for storing information and instructions to be executed by processor 204. In one implementation, the main memory 206 is used for storing temporary variables or other intermediate information during execution of instructions to be executed by the processor 204. Such instructions, when stored in non-transitory storage media accessible to the processor 204, render the computer system 200 into a special-purpose machine that is customized to perform the operations specified in the instructions.

In an embodiment, the computer system 200 further includes a read only memory (ROM) 208 or other static storage device coupled to the bus 202 for storing static information and instructions for the processor 204. A storage device 210, such as a magnetic disk, optical disk, solid-state drive, or three-dimensional cross point memory is provided and coupled to the bus 202 for storing information and instructions.

In an embodiment, the computer system 200 is coupled via the bus 202 to a display 212, such as a cathode ray tube (CRT), a liquid crystal display (LCD), plasma display, light emitting diode (LED) display, or an organic light emitting diode (OLED) display for displaying information to a computer user. An input device 214, including alphanumeric and other keys, is coupled to bus 202 for communicating information and command selections to the processor 204. Another type of user input device is a cursor controller 216, such as a mouse, a trackball, a touch-enabled display, or cursor direction keys for communicating direction information and command selections to the processor 204 and for controlling cursor movement on the display 212. This input device typically has two degrees of freedom in two axes, a first axis (e.g., x-axis) and a second axis (e.g., y-axis), that allows the device to specify positions in a plane.

According to one embodiment, the techniques herein are performed by the computer system 200 in response to the processor 204 executing at least one sequences of at least one instructions contained in the main memory 206. Such instructions are read into the main memory 206 from another storage medium, such as the storage device 210. Execution of the sequences of instructions contained in the main memory 206 causes the processor 204 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 210. Volatile media includes dynamic memory, such as the main memory 206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 202. Transmission media can also take the form of acoustic or light waves, such as those generated during radio-wave and infrared data communications.

In an embodiment, various forms of media are involved in carrying at least one sequences of at least one instructions to the processor 204 for execution. For example, the instructions are initially carried on a magnetic disk or solid-state drive of a remote computer. The remote computer loads the instructions into its dynamic memory and send the instructions over a telephone line using a modem. A modem local to the computer system 200 receives the data on the telephone line and use an infrared transmitter to convert the data to an infrared signal. An infrared detector receives the data carried in the infrared signal and appropriate circuitry places the data on the bus 202. The bus 202 carries the data to the main memory 206, from which processor 204 retrieves and executes the instructions. The instructions received by the main memory 206 can optionally be stored on the storage device 210 either before or after execution by processor 204.

The computer system 200 also includes a communication interface 218 coupled to the bus 202. The communication interface 218 provides a two-way data communication coupling to a network link 220 that is connected to a local network 222. For example, the communication interface 218 is an integrated service digital network (ISDN) card, cable modem, satellite modem, or a modem to provide a data communication connection to a corresponding type of telephone line. As another example, the communication interface 218 is a local area network (LAN) card to provide a data communication connection to a compatible LAN. In an embodiment, wireless links are also implemented. In any such implementation, the communication interface 218 sends and receives electrical, electromagnetic, or optical signals that carry digital data streams representing various types of information.

The network link 220 typically provides data communication through at least one networks to other data devices. For example, the network link 220 provides a connection through the local network 222 to a host computer 224 or to a cloud data center or equipment operated by an Internet Service Provider (ISP) 226. The ISP 226 in turn provides data communication services through the world-wide packet data communication network now commonly referred to as the “Internet” 228. The local network 222 and Internet 228 both use electrical, electromagnetic or optical signals that carry digital data streams. The signals through the various networks and the signals on the network link 220 and through the communication interface 218, which carry the digital data to and from the computer system 200, are example forms of transmission media.

The computer system 200 sends messages and receives data, including program code, through the network(s), the network link 220, and the communication interface 218. In an embodiment, the computer system 200 receives code for processing. The received code is executed by the processor 204 as it is received, and/or stored in storage device 210, or other non-volatile storage for later execution.

### Autonomous Vehicle Architecture

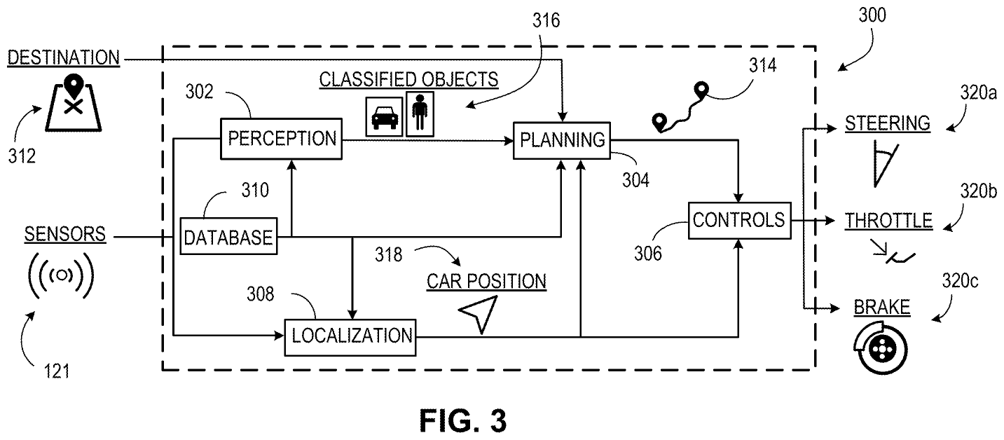

FIG. 3 shows an example architecture 300 for an autonomous vehicle (e.g., the vehicle 100 shown in FIG. 1). The architecture 300 includes a perception module 302 (sometimes referred to as a perception circuit), a planning module 304 (sometimes referred to as a planning circuit), a control module 306 (sometimes referred to as a control circuit), a localization module 308 (sometimes referred to as a localization circuit), and a database module 310 (sometimes referred to as a database circuit). Each module plays a role in the operation of the vehicle 100. Together, the modules 302, 304, 306, 308, and 310 can be part of the AV system 120 shown in FIG. 1. In some embodiments, any of the modules 302, 304, 306, 308, and 310 is a combination of computer software (e.g., executable code stored on a computer-readable medium) and computer hardware (e.g., at least one microprocessors, microcontrollers, application-specific integrated circuits [ASICs]), hardware memory devices, other types of integrated circuits, other types of computer hardware, or a combination of any or all of these things). Each of the modules 302, 304, 306, 308, and 310 is sometimes referred to as a processing circuit (e.g., computer hardware, computer software, or a combination of the two). A combination of any or all of the modules 302, 304, 306, 308, and 310 is also an example of a processing circuit.

In use, the planning module 304 receives data representing a destination 312 and determines data representing a trajectory 314 (sometimes referred to as a route) that can be traveled by the vehicle 100 to reach (e.g., arrive at) the destination 312. In order for the planning module 304 to determine the data representing the trajectory 314, the planning module 304 receives data from the perception module 302, the localization module 308, and the database module 310.

The perception module 302 identifies nearby physical objects using at least one sensors 121, e.g., as also shown in FIG. 1. The objects are classified (e.g., grouped into types such as pedestrian, bicycle, automobile, traffic sign, etc.) and a scene description including the classified objects 316 is provided to the planning module 304.

The planning module 304 also receives data representing the AV position 318 from the localization module 308. The localization module 308 determines the AV position by using data from the sensors 121 and data from the database module 310 (e.g., a geographic data) to calculate a position. For example, the localization module 308 uses data from a GNSS (Global Navigation Satellite System) sensor and geographic data to calculate a longitude and latitude of the AV. In an embodiment, data used by the localization module 308 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In an embodiment, the high-precision maps are constructed by adding data through automatic or manual annotation to low-precision maps.

The control module 306 receives the data representing the trajectory 314 and the data representing the AV position 318 and operates the control functions 320a-c (e.g., steering, throttling, braking, ignition) of the AV in a manner that will cause the vehicle 100 to travel the trajectory 314 to the destination 312. For example, if the trajectory 314 includes a left turn, the control module 306 will operate the control functions 320a-c in a manner such that the steering angle of the steering function will cause the vehicle 100 to turn left and the throttling and braking will cause the vehicle 100 to pause and wait for passing pedestrians or vehicles before the turn is made.

### Autonomous Vehicle Inputs

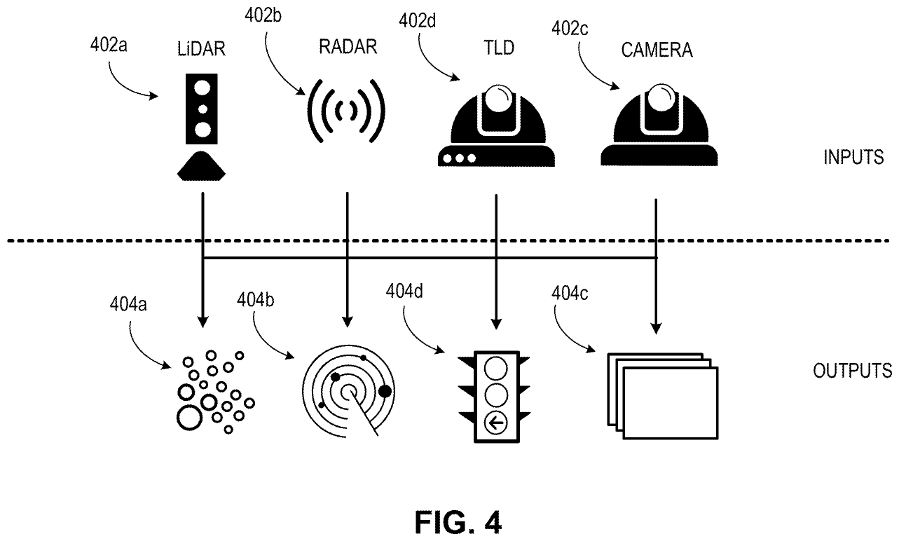

FIG. 4 shows an example of inputs 402a-d (e.g., sensors 121 shown in FIG. 1) and outputs 404a-d (e.g., sensor data) that is used by the perception module 302 (FIG. 3). One input 402a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 404a. For example, LiDAR data is collections of 3D or 2D points (also known as a point clouds) that are used to construct a representation of the environment 190.

Another input 402b is a RADAR system. RADAR is a technology that uses radio waves to obtain data about nearby physical objects. RADARs can obtain data about objects not within the line of sight of a LiDAR system. A RADAR system produces RADAR data as output 404b. For example, RADAR data are at least one radio frequency electromagnetic signals (e.g., radar echoes) that are used to construct a representation of the environment 190.

Another input 402c is a camera system. A camera system uses at least one cameras (e.g., digital cameras using a light sensor such as a charge-coupled device [CCD]) to obtain information about nearby physical objects. A camera system produces camera data as output 404c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In some embodiments, the camera system is configured to “see” objects far, e.g., up to a kilometer or more ahead of the AV. Accordingly, in some embodiments, the camera system has features such as sensors and lenses that are optimized for perceiving objects that are far away.

Another input 402d is a traffic light detection (TLD) system. A TLD system uses at least one cameras to obtain information about traffic lights, street signs, and other physical objects that provide visual navigation information. A TLD system produces TLD data as output 404d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the vehicle 100 has access to all relevant navigation information provided by these objects. For example, the viewing angle of the TLD system is about 120 degrees or more.

In some embodiments, outputs 404a-d are combined using a sensor fusion technique. Thus, either the individual outputs 404a-d are provided to other systems of the vehicle 100 (e.g., provided to a planning module 304 as shown in FIG. 3), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before at least one data processing steps are applied to the combined output. In some embodiments, a late fusion technique is used. A late fusion technique is characterized by combining outputs after at least one data processing steps are applied to the individual outputs.

### Trailering System for Auxiliary Vehicles

A trailering system is used for attaching an auxiliary vehicle (e.g., trailered vehicle) to a primary vehicle (e.g., an autonomous vehicle [AV]). A trailered vehicle connected to an AV obscures sensor lines of sight through which AV sensors receive information on the surrounding environment. Accordingly, the trailering system includes at least one sensing device, sometimes referred to as a sensor, reversibly attached to a surface or attachment point on the trailered vehicle providing additional data to the AV and increasing the AV perception of the surrounding environment. The AV utilizes the additional data in trajectory calculation and path planning to increase localization and path planning accuracy and overall safety of the combine vehicle system.

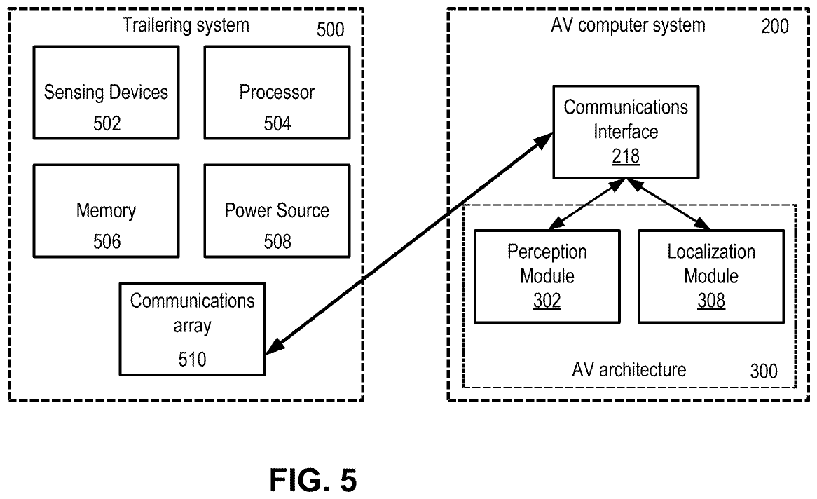

FIG. 5 is a schematic diagram of trailering system 500 components including at least one sensing devices 502 (referred to individually as sensing device 502 and collectively as sensing devices 502), at least one processor 504, memory 506, power source 508, and communications array 510. Sensing devices 502 can include any input system described in FIG. 4 (e.g., inputs 402a-d, LiDAR, RADAR, or camera), or any sensor type from which perception module 302 is configured to be in communication with (e.g., to receive outputs from). Additional examples of sensing devices 502 include accelerometers, magnetometers, night vision cameras (e.g., infrared cameras), GPS receivers, ultrasonic sensors, TOF sensors, temperature sensors, humidity sensors, precipitation sensors, and/or the like. In some embodiments, the trailering system 500 does not include processor 504. In such examples, the trailering system 500 can provide signals received from the at least one sensing device 502 to the AV for processing using local processors, such as processor 204 (FIG. 2).

Sensing devices 502 further include at least one attachment device for temporary attachment of sensing devices 502 to trailered vehicle 615. Attachment devices can include mechanisms, or combination of mechanisms, which can be temporarily attached to a surface or docking location. Examples of attachment devices include magnets, hitches, couplers, suction cups, and/or the like. The attachment device provides a temporary connection to trailered vehicle 615 at an arbitrary location, e.g., a location selected by the user.

In an embodiment, the attachment device provides a temporary connection between multiple sensing devices 502 such that a sensing device 502 can be detached from trailered vehicle 615 and a different sensing device 502 can be attached (e.g., swapped) to trailered vehicle 615 using the same attachment device. For example, the attachment device can include a female port and the input system a male plug that, when inserted into the female port, establishes a temporary connection to the attachment device which can then be attached to the trailered vehicle 615. In such an embodiment, an installed attachment device can remain on trailered vehicle 615 and an input system installed or exchanged. In an embodiment, trailered vehicle 615 includes at least one semi-permanent attachment site such as a hitch or coupler to which removable input systems attach.

Referring again to FIG. 5, processor 504 processes instructions for execution within trailering system 500, including instructions stored in memory 506. Memory 506 stores information within trailering system 500. In an embodiment, memory 506 is a volatile memory unit or units. In an embodiment, memory 506 is a non-volatile memory unit or units. Memory 506 may also be another form of computer-readable medium, such as a magnetic or optical disk.

Power source 508 includes, for example, a battery, battery pack, and/or outlet adapter, an AC to DC converter, a DC to AC converter, a power conditioner, a capacitor bank, and/or one or more interfaces for providing power to trailering system 500. In an embodiment, trailering system 500 receives primary or supplementary power from the AV through a temporary electrical connection (e.g., wired connection).

Communications array 510 is a radio device providing any technologically appropriate communication interface, including but not limited to multiple communication interfaces such as Wi-Fi, Bluetooth®, or copper wire connection. In an embodiment, communications array 510 is a radio device communicating on millimeter wavelength frequencies (e.g., mm wave radio) corresponding to a wavelength range of between 10 mm (e.g., 30 GHz) and 1 mm (e.g., 300 GHz). In an embodiment, communications array 510 is a 5G device. In an example, communications array 510 is more than one communications interface.

Processor 504 processes input received from sensing devices 502 into output which communications interface 218 of AV computer system 200 receives from communications array 510. The AV architecture 300 perception module 302 uses trailering system 500 output to receive data associated with reflected signals (e.g., point cloud, radar echo, optical signal) from the environment and identify nearby objects (e.g., vehicles, persons, street signs). In some embodiments, AV localization module 308 also uses trailering system 500 output as supplementary information to determine the trailered vehicle position with respect to the environment or with respect to the AV. In an embodiment, processor 504 receives data associated with reflected signals and calculates a localization estimation of trailering system 500 which communications array 510 provides to the AV. AV localization module 308 utilizes trailering system 500 localization estimation in determining a localization estimation of the AV.

In general sensing devices 502 can attach to any surface or point (e.g., roof, door, side, window, and/or the like) capable of sustaining a temporary connection with sensing device 502 and also provide clear lines of sight for reflected signals from the surrounding environment.

In an example, trailering system 500 includes multiple sensing devices 502 in a single housing and connects to the trailered vehicle using a single attachment mechanism. In a second example, multiple sensing devices 502 of trailering system 500 include respective processors 504, memory 506, power sources 508, and communications arrays 510 for independent operation while in communication with trailering system 500.

In an embodiment, trailering system 500 determines at least one distance measurement and/or a relative position to determine at least one dimension of the trailered vehicle. For example, trailering system 500 determines a relative position of at least one sensing device 502 with respect to the AV. The relative position includes spatial information such as a horizontal position, or a vertical position with respect to at least one sensor of the AV.

Processor 504 of trailering system 500 calculates a distance between at least one sensing device 502 and the AV based upon at least the relative position of the sensing device 502. For example, a RADAR sensing device receives a reflected signal and processor 504 performs a time-of-flight calculation based upon the reflected signal to determine a relative position and distance to the AV. As a second example, a LiDAR sensing device 502 of trailering system 500 determines a point cloud of the surrounding environment, or at least two camera sensing devices 502 receive images from the surrounding environment, and the processor 504 of trailering system 500 performs a calculation based upon the stereo optical information received to determine a dimension of the trailered vehicle.

Trailering system 500 receives reflected signals from sensing devices 502 and processes them individually into output to provide to the AV. In an embodiment, processor 504 combines the reflected signal outputs into a data structure representing a merged reflected signal (e.g., a composite of each of the reflected signals) and provides the data structure representing the merged reflected signal to the AV (e.g., to one or more systems included in the AV). In a further embodiment, processor 504 combines the reflected signal outputs into a data structure representing a merged reflected signal and determines a trailered vehicle localization estimation based upon the merged reflected signal and provides the localization estimation to the AV.

Trailering system 500 calculates at least one dimension of the trailered vehicle based upon the determined relative position and distance from the AV. In an example, the trailering system 500 includes at least one sensing device 502 capable of perceiving a whole dimension (e.g., the length) of the trailered vehicle. The at least one sensing device 502 receives reflected signals from the trailered vehicle and the processor 504 determines the whole dimension from the reflected signals. In some embodiments, the trailering system 500 includes at least two sensing devices 502, each capable of perceiving a partial dimension of the trailered vehicle. The at least two sensing devices 502 receive reflected signals corresponding to the partial dimension and provides the signals to the processor 504 from which a whole dimension is then determined.

The dimension includes a spatial dimension value (e.g., feet, meter) corresponding to a height, length, or width of the trailered vehicle. In a further embodiment, trailering system 500 includes a table in memory 506 (e.g., a database, a look-up table) including at least one dimension value that corresponds with a trailered vehicle classification (e.g., shipping container, tractor-trailer, boat, articulating bus). The processor 504 of trailering system 500 calculates the at least one dimension value of the trailered vehicle and determines from the table stored in memory 506 a trailered vehicle classification and supplies the AV with the trailered vehicle classification.

In some embodiments, the trailering system 500 calculates a distance from the trailered vehicle to a second location. In a first example, the trailering system 500 is attached to the trailered vehicle at a relative position and distance from the AV and the second location is a nearby second vehicle. The at least one sensing devices 502 of the trailering system 500, e.g., a camera, a LiDAR receiver, receives reflected signals from the nearby second vehicle and processor 504 determines a second distance to the second vehicle. The trailering system 400 provides the second distance to the AV.

In a second example, the second vehicle includes a communications array capable of communicating with the trailering system 500 (e.g., GPS transceiver, Wi-Fi, or mm wave radio). The second vehicle establishes a communicative connection with the communications array 510 and provides the second vehicle localization estimation to the trailering system 500. For example, the trailering system 500 then provides the second vehicle localization estimation to the AV for further processing in path planning and control.

In a third example, the second location can be a fixed location, such as a trailer dock, parking spot, or bay. The at least one sensing devices 502 of the trailering system 500 receives reflected signals corresponding to the fixed location. In some embodiments, the fixed location can include at least one fiducial marker (e.g., reflective marker, high-visibility paint, or symbol) corresponding to the fixed location. Alternatively, the fixed location can include a communications array to establish a communicative connection with the trailering system 500, such as a GPS transceiver, Wi-Fi, or millimeter wave radio beacon. The trailering system 500 receives, or determines from received signals, a localization estimation from the fixed location communications array and provides the localization estimation to the AV.

### Exemplary Embodiment

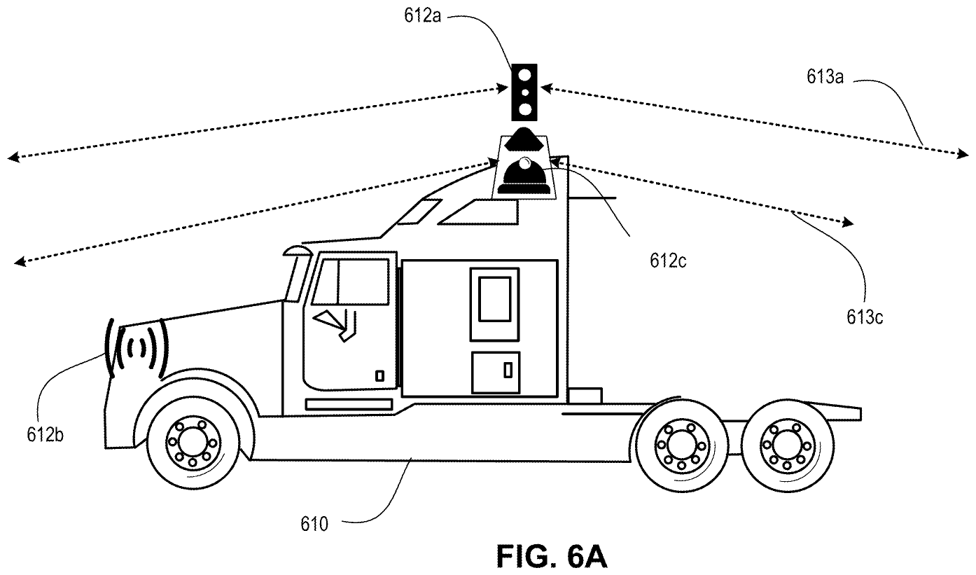

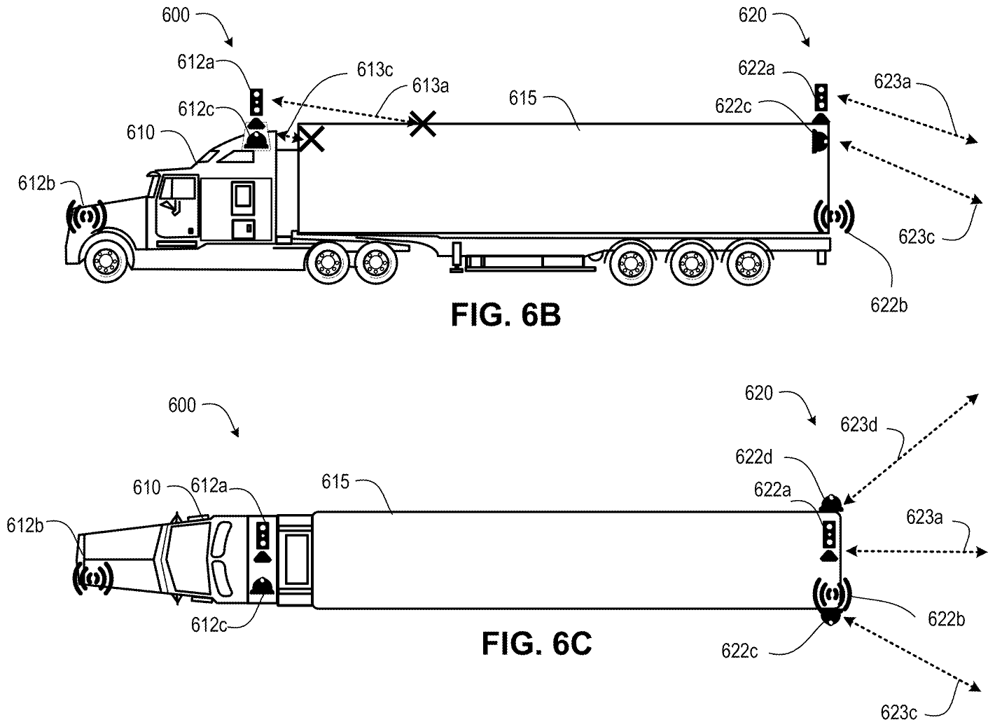

FIG. 6A shows an example AV 610 (e.g., an AV that is the same as or similar to AV 100 shown in FIG. 1) including a number of integrated sensors 612a-c (e.g., sensors 121 shown in FIG. 1) for perceiving the surrounding environment. Sensors 612a-c provide sensor data to AV 610 perception module 302 which further provides the sensor data to requesting modules in AV 610, such as localization module 308. Depicted AV 610 is a tractor truck with a fifth wheel hitch for connection with trailering semi-trailers. Other examples of AV 610 can include passenger vehicles, motorized tugs, or other commercial or industrial trucks.

Example sensors 612a-c include a LiDAR system 612a, RADAR system 612b, and camera system 612c. Each sensor 612a-c depends on a line-of-sight view to nearby objects to receive a reflected signal (e.g., LiDAR point cloud, RADAR echo, optical signal) from the object, such as vehicles or pedestrians. For example, LiDAR system 612a receives a reflected laser signal 613a, RADAR system 612b receives a reflected radio signal, and camera system 612c receives a reflected light signal 613c. Using these reflected signals, e.g., 613a, 613c, AV 610 perception module 302 builds an estimation of the surrounding environment.

FIG. 6B shows an example combined vehicle 600 including example AV 610 of FIG. 6A and trailered vehicle 615 connected to AV 610 through a temporary connection, such as a hitch, or fifth wheel. As depicted, trailered vehicle 615 is a semi-trailer though examples of other trailered vehicles include two-wheel trailers, reefer trailers, flatbed trailers, camper trailers, recreational vehicles, autorack trailers, grain hopper trailers, livestock trailers, trailered boats, towed second vehicles, and/or the like. In an embodiment, the connection can include electrical connections to supply power and/or receive electrical signals from trailered vehicle 615 and/or trailering system 620.

Forward-facing sensors of AV 610, such as RADAR system 612b, retain their respective lines of sight to receive reflected signals from nearby objects. However, sensors with rear-facing lines-of-sight responsible for determining the environment to the rear of AV 610 experience reduced visibility and receive reflected signals from trailered vehicle 615 surfaces rather than objects in the environment. For example, reflected signals 613a, 613c reflect from trailered vehicle 615 surfaces, partially or totally obscuring the surrounding environment from those signals. This creates areas lacking environmental information (e.g., blind spots) for AV 610. The removable sensor outputs provide additional information about the surrounding environment to AV 610 and can include information about at least a portion of the blind spot(s).

As shown in FIG. 6B, trailered vehicle 615 includes a trailering system 620 including three sensing devices 622a-c. Trailering system 620 includes LiDAR sensing device 622a, RADAR sensing device 622b, and camera sensing device 622c attached to the rear end of trailered vehicle 615. LiDAR sensing device 622a is attached to the upper surface, camera sensing device 622c is attached to the side surface proximal to the upper surface, and RADAR sensing device 622b is attached to the rear surface of trailered vehicle 615.

The positioning of sensing devices 622a-c on trailered vehicle 615 establishes clear lines of sight such that sensing devices 622a-c receive reflected signals from the surrounding environment, demonstrated by reflected signals 623a, and 623c. Sensing devices 622a-c receive the reflected signal and produce outputs respective to the sensing device type (e.g., LiDAR data, RADAR data, or camera data).

Sensing devices 622a-c receive reflected signals from the rear surfaces of trailered vehicle 615 when attached near the rear surfaces. In an embodiment, trailering system 500 utilizes processor 504 to detect at least one component of trailered vehicle 615 experiencing partial- or fully failed operation (e.g., a fault). For example, a camera sensing device 622c detects light emitted from an operational lightbulb near the rear surface of trailered vehicle 615 (e.g., a tail light) but does not detect light emitted from the paired operational lightbulb opposite the functional lightbulb. Trailering system 500 sends a light-fault notification to the AV indicating the faulty function and the AV can display the notification to the user.

In another example, a faulty tire (e.g., flat, damaged, or low pressure) on one side of trailered vehicle 615 causes high amplitude random motion on a side surface. This motion is detected by a first sensing device 502 attached to the same side surface and not detected by a second sensing device 502 attached to the opposing side surface. Trailering system 500 sends a tire-fault notification to the AV for display to the user. In a further example, the faulty tire causes debris to appear within a view of at least one sensing device 502. Trailering system 500 detects the debris and, alone or in combination with detected random motion signals, sends a tire-fault notification to the AV for display to the user.

FIG. 6C shows a top-down view of example combined vehicle 600 of FIG. 6B including AV 610 and trailered vehicle 615. FIG. 6C shows trailering system 620 including an additional camera sensing device 622d attached to the surface opposite camera sensing device 622c. Reflected signals 623a, 623c, and 623d are shown corresponding to unobstructed lines of sight of nearby objects and surrounding environment.

A trailered vehicle 615 complicates the determination of AV 610 trajectory 314 by adding additional dimensions to AV 610 articulable around the attachment point of AV 610 to trailered vehicle 615. When AV 610 determines and travels along a trajectory 314 in which trailered vehicle 615 is pulled behind AV 610 (e.g., forward travel), trailering system 620 provides output to AV 610 regarding the relative position of AV 610 relative to the surrounding environment of trailered vehicle 615 while AV 610 operates control functions 320a-c to travel along trajectory 314.

In an embodiment, AV 610 determines a trajectory 314 in which trailered vehicle 615 is pushed by the AV 610 (e.g., reverse travel). In such embodiments, trailering system 620 includes at least one additional processor (e.g., a second processor) communicatively coupled to processor 504 which operates control functions 320a-c responsive to output received from the connected sensing devices. In an embodiment, the second processor (or first processor 504) of trailering system 620 sends control signals to independently operate control functions 320a-c to travel trajectory 314.

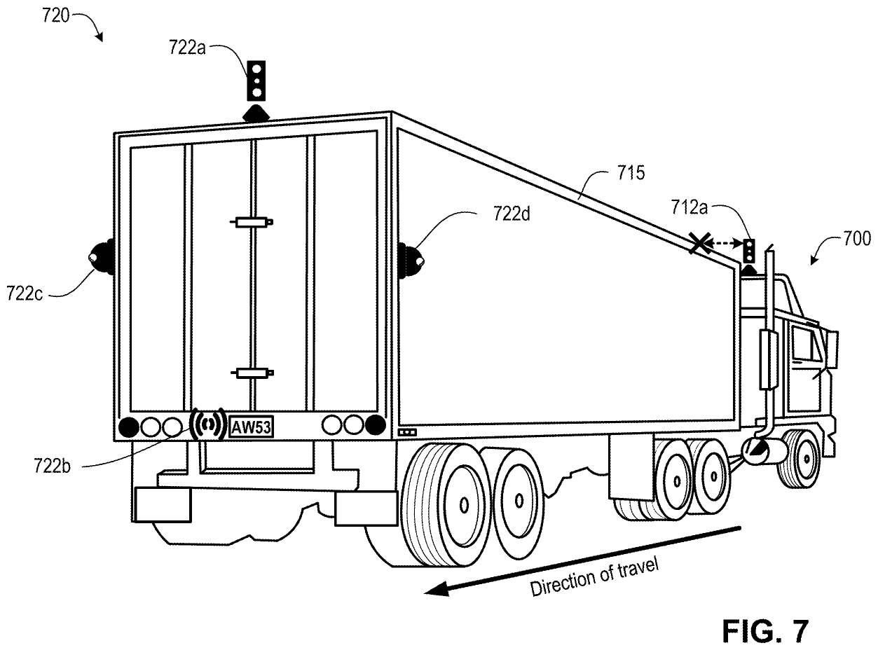

FIG. 7 depicts AV 700 with integrated LiDAR sensor 712a receiving obstructed reflected signals from trailered vehicle 715. Trailering system 720 attaches to trailered vehicle 715 including LiDAR sensing device 722a on the upper surface, RADAR sensing device 722b on a rear surface, and two camera sensing devices, 722c and 722d, arranged in stereo across side surfaces. In the example of FIG. 7, the direction of travel is shown (e.g., reverse motion). Trailering system 720 receives unobstructed reflected signals representing a relative position and velocity in the direction of travel from the environment and processes the received inputs into outputs. AV 700 receives the output from trailering system 720 and calculates a trajectory 314. AV 700 operates control functions 320a-c to travel trajectory 314. In an embodiment, trailering system 720 calculates trajectory 314 and communications instructions to AV 700 control functions 320a-c to travel trajectory 314.

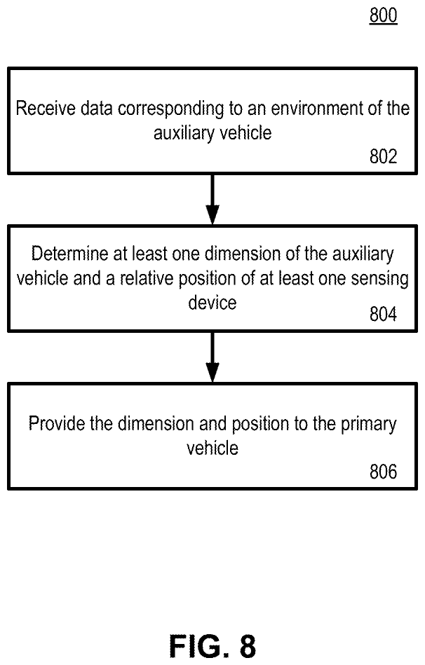

FIG. 8 is a flowchart representing a process 800 for providing information corresponding to an auxiliary vehicle to a reversibly-attached primary vehicle. In an embodiment, the auxiliary vehicle is auxiliary vehicle 615 shown in FIG. 6, the primary vehicle is AV 610 in FIG. 6 or AV 100 in FIG. 1, and process 800 is carried out by a processor such as processor 504 shown in FIG. 5 or perception module 402 shown in FIG. 4.

The trailering system processor receives 802 data, e.g., reflected signals, corresponding to an environment of the auxiliary vehicle from the at least one sensing device. The data corresponding to an environment includes at least one reflected signal received by at least one sensing device of the trailering system, such as a LiDAR point cloud, RADAR echo, or optical signal. In an embodiment, the at least one sensing device includes the sensing devices of FIG. 5, e.g., LiDAR, RADAR, camera, or any sensing device described herein.

The trailering system processor determines 804 at least one dimension of the auxiliary vehicle and a relative position of the at least one sensing device from a primary vehicle based on the data received from the reflected signals from auxiliary vehicle environment. In some embodiments, the trailering system determines the at least one dimension and the relative position using reflected signals from the environment. In some embodiments, the trailering system receives the reflected signals from the environment and generates a merged reflected signal based on the reflected signals.

In some embodiments, the trailering system processor determines a vehicle classification based upon the determined dimension and relative position for the auxiliary vehicle from the primary vehicle. In some embodiments, the trailering system processor determines a sensor location at which the at least one sensing device is releasably attached based upon the determined dimension and relative position for the auxiliary vehicle from the primary vehicle.

The system processor provides 806 the at least one dimension and the relative position of the at least one sensing device to the primary vehicle. In some embodiments, the trailering system includes a communications array for providing information to the primary vehicle, such as communications array 510 communicating on millimeter wavelength frequencies (e.g., mm wave radio, 5G device). In some embodiments, the information provided to the primary vehicle is a localization estimation based on the merged reflected signal in 804. In some embodiments, the information provided to the primary vehicle is a vehicle classification, or sensor location as determined in 804.

In the foregoing description, embodiments of the invention have been described with reference to numerous specific details that may vary from embodiment to embodiment. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A system comprising:
at least one sensor comprising at least one attachment configured to removably attach to an auxiliary vehicle, the auxiliary vehicle configured for attachment to a primary vehicle;
at least one computer-readable medium storing computer-executable instructions;
at least one first processor communicatively coupled to the at least one sensor and configured to execute the computer-executable instructions, the execution carrying out operations including:
receiving data corresponding to an environment of the auxiliary vehicle from the at least one sensor;
determining at least one dimension of the auxiliary vehicle and a relative position of the at least one sensor from a primary vehicle based on the environment of the auxiliary vehicle; and
providing the at least one dimension and the relative position of the at least one sensor to the primary vehicle based on the at least one dimension of the auxiliary vehicle and the relative position of the at least one sensor.

2. The system of claim 1, further comprising:
at least one second processor communicatively coupled to the at least one first processor, wherein the second processor is configured to:
operate the primary vehicle based upon data received from the at least one sensor.

3. The system of claim 2, further comprising a communications array.

4. The system of claim 3, wherein the communications array is configured to transmit and receive data in a frequency range of between 30 GHz and 300 GHz.

5. The system of claim 4, wherein providing the at least one dimension and the relative position of the at least one sensor to the primary vehicle comprises:
providing the at least one dimension and the relative position of the at least one sensor to the primary vehicle using the communications array.

6. The system of claim 1, wherein the execution further comprises carrying out the following operation:
detecting objects based on the environment of the auxiliary vehicle.

7. The system of claim 1, wherein the execution further comprises carrying out the following operation:
detecting at least one fault in the auxiliary vehicle.

8. The system of claim 1, further comprising:
a power source configured to provide power to the at least one sensor, the at least one computer-readable medium, and the at least one first processor.

9. The system of claim 1, wherein receiving data corresponding to the environment comprises:
receiving data associated with a reflected signal from each sensor of the at least one sensor;
generating a merged reflected signal based on the reflected signal received from each sensor of the at least one sensor;
determining a localization estimation based on the merged reflected signal; and
providing the localization estimation to the primary vehicle.

10. The system of claim 1, wherein the determining further includes:
determining, from the at least one dimension of the auxiliary vehicle and the relative position of the at least one sensor from the a primary vehicle, a vehicle classification of the auxiliary vehicle;
establishing, from the at least one dimension of the auxiliary vehicle and the relative position of the at least one sensor from the a primary vehicle, a sensor location at which the at least one sensor is releasably attached; and
providing the vehicle classification and the sensor location to the primary vehicle.

11. A method comprising:
receiving data corresponding to an environment of an auxiliary vehicle from at least one sensor configured to removably attach to the auxiliary vehicle, the auxiliary vehicle configured for attachment to a primary vehicle;
determining at least one dimension of the auxiliary vehicle and a relative position of the at least one sensor from the primary vehicle based on the environment of the auxiliary vehicle; and
providing the at least one dimension and the relative position of the at least one sensor to the primary vehicle based on the at least one dimension of the auxiliary vehicle and the relative position of the at least one sensor.

12. A non-transitory computer-readable storage medium comprising at least one program for execution by at least one processor of a first device, the at least one program including instructions which, when executed by the at least one processor, cause the first device to perform operations comprising:
receiving data corresponding to an environment of an auxiliary vehicle from at least one sensor configured to removably attach to the auxiliary vehicle, the auxiliary vehicle configured for attachment to a primary vehicle;
determining at least one dimension of the auxiliary vehicle and a relative position of the at least one sensor from the primary vehicle based on the environment of the auxiliary vehicle; and
providing the at least one dimension and the relative position of the at least one sensor to the primary vehicle based on the at least one dimension of the auxiliary vehicle and the relative position of the at least one sensor.
